(19) United States
(12) Patent Application Publication
(10) Pub. No.: US 2020/0028449 A1
(43) Pub. Date: Jan. 23, 2020

(54) IMPROVEMENTS IN THE REGULATION AND CONTROL OF SWITCH MODE POWER SUPPLIES

(71) Applicant: ENATEL LIMITED, Hamilton (NZ)

(72) Inventors: Dennis Alan CHAPMAN, Hamilton (NZ); Robert James STUART, Hamilton (NZ)

(21) Appl. No.: 16/065,624

(22) PCT Filed: Dec. 21, 2016
(86) PCT No.: PCT/NZ2016/050202

§ 371 Date: Jun. 22, 2018

(30) Foreign Application Priority Data
Dec. 24, 2015 (NZ) 715591

(51) Int. Cl. H02M 7/797; H02M 1/00

(52) U.S. Cl. CPC H02M 7/797; H02M 2001/0009; H02M 1/00

(57) ABSTRACT

A predictive controller and method for predictive control of the output of a switched mode power supply are disclosed. At least one dependent variable related to an output of the switch mode power supply to be controlled is measured. At least one non-ideal switching characteristic of the power supply is measured, substantially in real-time. At least one substantially real-time physical property of the switch mode power supply is calculated based on the non-ideal switching characteristic. An adjustment to at least one independent variable of the switch mode power supply required to adjust the output of the switch mode power supply to be controlled is calculated based on the measured dependent variable and calculated real-time physical property. The independent variable of the switch mode power supply is then adjusted.

### STATEMENT OF CORRESPONDING APPLICATIONS

This application is based the provisional specification filed in relation to New Zealand Patent Application No. 715591, the entire contents of which are incorporated herein by reference.

### TECHNICAL FIELD

This application relates to improvements in the regulation and control of switch mode power supplies (SMPS) and in particular to model predictive control methods and systems for implementing such methods.

### BACKGROUND

Switch mode power supplies (“SMPS”) employ a variety of control architectures and techniques for the control and regulation of output characteristics. The purpose of the SMPS controller is to maintain an output of the SMPS at a desired level and to compensate for fluctuations in loading and variations in the system response characteristics over time. In more complex systems a number of SMPS's share a common load, in such cases the controller in each SMPS must also work in unison with the controllers in the other SMPS to evenly distribute the load demand.

One control technique that is commonly used in industrial plant is a predictive control technique, generally referred to as model predictive control (MPC).

MPC relies on measurement of one or more independent variables of the plant, the current dynamic state of the plant and a desired future value of an output of the plant. MPC calculates future changes in the dependent plant variables that will result in the independent variables reaching the future plant targets.

MPC is an iterative process in which the plant state is sampled on a continuous basis and the calculations are repeated starting from the new current state, yielding new adjustments to the independent variable.

One of the problems with MPC is that there is a high processing burden necessary to compute, in real time, the necessary adjustments to achieve the future plant target. This is particularly true for systems that are not easily modelled as a lower order system. For this reason MPC is typically used for relatively simple approximately linear models, with any non-linearity errors in the model being compensated by an iterative feedback path in an MPC system.

Due to the complexity in modelling, and non-linearity, of an SMPS response; MPC has not been a practical solution for the control of SMPS systems. Specifically, the processing time required to compute adjustments to achieve a future SMPS output must be less than the desired response time of the SMPS. In order for MPC to be viable the processing time must be shorter, or equal to, what is possible with current control methodologies, such as, proportional integral derivative (PID) control.

Known MPC techniques rely on a static model of the plant being controlled. This introduces a further problem with using MPC in complex systems, in which the performance of an MPC controller can degrade when system model mismatch is present, i.e. when the system model being used by the MPC controller does not adequately match the actual system response characteristics.

Sensitivity to model mismatch is one of the main reasons why MPC controllers tend to perform worse than other types of control strategies, such as PID control, when used for complex non-linear systems. The most common technique to address model mismatch in MPC systems is to tune the controller. Because of the difficulties in tuning controllers, however, control system designers frequently tune a controller for the worst case scenario to ensure stability over a desired operating range and accept suboptimal tuning during operation within the operating range. The default tuning parameters of many MPC controllers is therefore typically conservative, so that these tuning parameters can work initially for a variety of system variations. If optimal performance is desired the MPC controller is tuned for the specific system in which it is operating. However, this does not address the issue of drift where the system response characteristics vary over time, in which case system performance can degrade.

One method of “tuning” an MPC controller in response to model mismatch is to regenerate the process model in light of process changes and then use this new model within the MPC controller. However, this technique is only practical for systems that can be modelled relatively simply. The reason being that regeneration of the system model places additional burden on the controller, which for complex models is near capacity when calculating future changes in the dependent plant variables, leaving no further capacity for regenerating the model.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### SUMMARY

The present disclosure relates to a system and method for controlling the output of a switched mode power supply (“SMPS”). Many control strategies may be used to control the output of power supplies, most commonly a comparative feedback technique is used. In this type of system an output variable is measured and fed back to the control system, the control system also including a setpoint against which the fed back signal is compared. The controller adjusts the drive signals to the SMPS switching devices to adjust the measured output variable to match the setpoint. The designer of the control system must balance the requirements of response speed and stability for the particular system being designed for. In contrast to the feedback system that is traditionally used in SMPS control systems, the present disclosure relates to a predictive control strategy. Typically the same output variable is measured, however, rather than adjusting the drive signals to the SMPS devices based on a comparison, the controller of embodiments of the present disclosure may calculate a future drive signal based on a series of substantially real time measurements and computation based on real time physical properties of the SMPS. In addition, embodiments of the present disclosure may measure the change in the output variable in response to the calculated drive signal and calculate the real-time physical properties of the SMPS for use in a subsequent future drive signal computation.

According to an exemplary embodiment of the present disclosure there is provided a method for predictive control of the output of a switched mode power supply, the method including the steps of:
a) measuring at least one dependent variable related to an output of the switch mode power supply to be controlled;
b) measuring, substantially in real-time, at least one non-ideal switching characteristic of the power supply;
c) calculating at least one substantially real-time physical property of the switch mode power supply based on the non-ideal switching characteristic;
d) calculating, based on the measured dependent variable and calculated real-time physical property, an adjustment to at least one independent variable of the switch mode power supply required to adjust the output of the switch mode power supply to be controlled;
e) adjusting the independent variable of the switch mode power supply;
f) repeating steps a to e.

According to an exemplary embodiment of the present disclosure there is provided predictive controller for a switched mode power supply, the predictive controller including:
a sensing circuit configured to measure, in substantially real time:
   at least one dependent variable related to an output of the switch mode power supply, and
   at least one non-ideal switching characteristic of the power supply;
a controller in communication with the sensing circuit, configured to:
   calculate at least one substantially real-time physical property of the switch mode power supply based on the measured non-ideal switching characteristic;
   calculate a future adjustment to at least one independent variable of the switch mode power supply based on the measured dependent variable and the calculated real-time physical property; and
   adjust the independent variable based on the calculated future adjustment.

According to an exemplary embodiment of the present disclosure there is provided a switch mode power supply, including a predictive controller including:
a sensing circuit configured to measure, in substantially real time:
   a dependent variable related to an output of the switch mode power supply, and
   a non-ideal switching characteristic of the power supply;
a controller in communication with the sensing circuit, configured to:
   calculate at least one substantially real-time physical property of the switch mode power supply based on the measured non-ideal switching characteristic;
   calculate a future adjustment to at least one independent variable of the switch mode power supply based on the measured dependent variable and the calculated real-time physical property; and
   adjust the independent variable based on the calculated future adjustment.

According to an exemplary embodiment of the present disclosure there is provided a switch mode power supply including a predictive controller circuit, the predictive controller circuit including:
a sensing circuit configured to measure, in substantially real time:
   the input current of the switch mode power supply,
   the input voltage of the switch mode power supply,
   the output voltage of the switch mode power supply, and
   the resonance timing of a switching device of the switch mode power supply; and
a controller in communication with the sensing circuit configured to:
   calculate substantially in real-time the primary input inductance and the total capacitance of the switch mode power supply based on the measured resonance timing;
   calculate a future adjustment to the switching device drive pulse timing based on the measured input current, the measured input voltage and the measured output voltage and the calculated primary input inductance and the total capacitance;
   adjust the switching device drive pulse timing based on the calculated future adjustment.

The dependent variable that is measured may vary without limitation. Examples of suitable dependent variables may include at least one of, but not limited to: output current, output voltage, input current, input voltage, input power factor, supply frequency, and harmonic distortion.

Measurement of signals are typically made by using one or more discrete electronic components, such as resistors, capacitors, inductors or the like, or may be measured by a microprocessor in combination with one or more discrete electronic components. The exact configuration of the componentry used to perform the measurements may vary and exemplary embodiments described herein are not intended to be limiting. The term sensing unit should be understood to include within its scope all variations of sensing hardware and interfacing thereof to a microprocessor.

The non-ideal switching characteristic that is measured may vary without limitation. Examples of suitable non-ideal switching characteristics may include at least one of, but not limited to: switch ringing, signal to noise ratio, switch conductance, switch transconductance, and switch latency.

Non-ideal switching characteristics are typically produced as a result of parasitic or stray inductive and capacitive effects in a circuit. The parasitic or stray inductance and capacitance of a circuit is typically embodied in a number of discrete components in the circuit, such as circuit traces, switching devices, component leads and the like.

The magnitude of parasitic or stray capacitance and inductance may not be consistent between batches of the same components, circuit board layouts and may vary with temperature, operating environment and component age. For these reasons the magnitude of such stray or parasitic contributions is not consistent and therefore difficult to measure and accurately model.

In an exemplary embodiment the physical property of the switch mode power supply that is calculated in substantially real time may include the parasitic or stray inductance of at least a portion of the switch mode power supply circuit.

In an exemplary embodiment the physical property of the switch mode power supply that is calculated in substantially real time may include the parasitic or stray capacitance of at least a portion of the switch mode power supply circuit.

In an exemplary embodiment the parasitic or stray inductance and capacitance that is calculated may include at least one of, but not limited to: the trace inductance, component lead inductance, the switching device parasitic capacitance; the switch mode power supply output trace stray capacitance, and the switch mode power supply inter component stray capacitance.

In an exemplary embodiment the physical property of the switch mode power supply that is calculated in substantially real time may include the input inductance.

In an exemplary embodiment the physical property of the switch mode power supply is calculated in substantially real time may include the total capacitance.

The independent variable of the switch mode power supply that is adjusted to vary the output of the switch mode power supply may vary without limitation. Examples of such independent variables may include at least one of, but not limited to: switching frequency, switching dead time, and switching duty cycle.

In an exemplary embodiment calculation of the adjustment to the independent variable of the switch mode power supply is determined from a set of design equations based on the specific design of switch mode power supply. The design equations may vary depending on the topology of the switch mode power supply circuit, for example, buck, boost, buck-boost, forward, half-bridge, full-bridge, push-pull, flyback, charge-pump and multiphase synchoronous converters will each have a combination of common design equations as well as topology specific equations. As such the exact form of the design equations should not be seen as being limiting.

In an exemplary embodiment at least one of the design equations may include as a variable the calculated physical property of the switch mode power supply.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

Control may be performed by a processor, and more particularly a microprocessor: a self-contained computer system capable of storing and executing software instructions, receiving input from peripheral circuitry and providing output signals to peripheral circuitry. The term microprocessor also encompasses field programmable gate arrays FPGA's that have been configured for the same purpose of controlling a switch mode power supply. A general purpose processor may be a microprocessor, but in the alternative, the processor may be any suitable processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

### BRIEF DESCRIPTION OF THE DRAWINGS

Further aspects of the present invention will become apparent from the ensuing description which is given by way of example only and with reference to the accompanying drawings in which:

FIG. 1 is a simplified schematic view of a switch mode power supply including a predictive controller in accordance with an exemplary embodiment of the present disclosure;

FIG. 2 is a switching waveform of a switching device shown in the circuit of FIG. 1;

FIG. 3A is a simplified block diagram for a predictive controller in accordance with an exemplary embodiment of the present disclosure;

FIG. 3B is a flow diagram representation for the operation of the predictive controller shown in the block diagram of FIG. 3;

FIG. 4 shows an example response curve for primary inductance and total capacitance for a predictive controller in accordance with an exemplary embodiment of the present disclosure;

FIG. 5A shows a switching waveform of a switching device shown in the circuit of FIG. 1

FIG. 5B shows a simplified schematic view of a switch mode power supply including a predictive controller in accordance with an exemplary embodiment of the present disclosure.

### DETAILED DESCRIPTION

### Definitions

Switched mode power supply (SMPS): refers to an electronic circuit that is configured to convert an input voltage and current to a regulated output voltage or current utilizing a method of switching a current path through one or more inductors and capacitors.

Dependent variable: refers to a measurable attribute of a SMPS that is controllable by adjusting the operating parameters of the switched mode power supply, for example the input current, output current, output voltage or the like.

Independent variable: refers to a measurable attribute of a SMPS that is not controllable by the SMPS but which affects one or more of the dependent variables of the SMPS, for example the input voltage.

Real-time: happening in the present, not based in the past or in the future.

Non-ideal switching characteristic: a characteristic of a component that is not present in an idealized model. For example, ideal switching characteristics of the voltage across a switching device will typically be an ideal square wave. In reality the switching waveform is non-ideal, exhibiting among other attributes, one or more of, a finite rise time, a finite fall time, overshoot, undershoot and ringing.

Rectifier mode: an SMPS that transfers power from an AC supply to a load, such as a battery charger.

Inverter mode: an SMPS that transfer power from a DC source to an AC supply, such as a solar inverter.

Bi-directional converter: an SMPS that can operate as an inverter and as a rectifier.

### Exemplary Embodiments

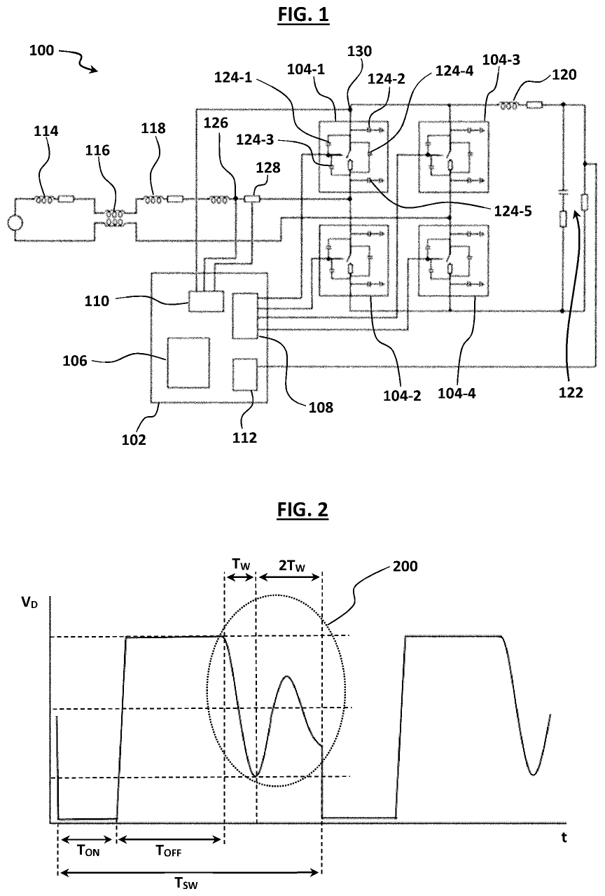

FIG. 1 shows a simplified schematic view of an SMPS in the form of a bi-directional converter, as generally indicated by designator 100. As shown, the system includes a control system 102 which provides drive signals to the switching devices 104-1 to 104-4. Non-limiting examples of suitable switching devices include MOSFETs, IGBT's, bipolar transistors or the like.

In the exemplary embodiment illustrated the control system 102 is implemented as a combination of a microprocessor 106 and an arrangement of discrete electronic components, shown as driver block 108, DC sensing block 110 and AC sensing block 112, each of which includes the hardware required for interfacing between the microprocessor 106 and the bi-directional converter 100 hardware. The exact configuration of the hardware may vary and as such should not be seen as a limitation on all embodiments of the present disclosure.

The bi-directional converter 100 depicted in FIG. 1 illustrates a number of non-ideal inductive and capacitive contributions to the overall circuit impedance, including primary trace impedance 114, common-mode choke impedance 116, secondary trace impedance 118, DC side trace impedance 120 and load impedance 122. In addition switching devices 104-1 to 104-4 each show parasitic capacitances 124-1 to 124-5. The non-ideal parameters shown are not intended to be exhaustive, but serve to indicate the underlying complexity of SMPS circuits.

The non-ideal characteristics 114, 116, 118, 120, 120, 122, and 124-1 to 124-5 each cause a deviation in the response of the SMPS over what would be expected for an ideal circuit. Furthermore, a number of the parameters shown vary with temperature, humidity, age and operating conditions as well as exhibiting variability between the same components of the same age.

The inherent variability of SMPS components makes generation of an accurate circuit model very difficult and the end result highly complex and computationally burdensome to process and regenerate for a model predictive control strategy.

A traditional control strategy, such as PID control, automatically adjusts for the effect of non-ideal characteristics. The reason for this is that traditional control strategies such as PID treat the SMPS hardware as a black box, driving the switching devices 104-1 to 104-4 purely on a comparative measurement between an output characteristic being controlled and a desired level for that output which is defined by hardware or within a microprocessor. PID works well unless there is variance in the feedback circuit. The problem with control strategies such as PID is that the response characteristics are static, that is to say the designer must define the response characteristics for optimal performance under particular conditions. This is straightforward for control of single unit SMPS, however as soon as load sharing is implemented the PID response must be adjusted to ensure that the individual SMPS controllers load balance effectively. Typically, load sharing results in slow response times to load perturbations.

Referring again to FIG. 1, the microprocessor 106 of control system 102 provides switching signals, not shown, to switching devices 104-1 to 104-4 by way of the interface hardware depicted by driver block 108. In order to avoid obfuscation of the present invention a discussion explaining the operation of a bi-directional converter is not provided, the theory behind switched mode power conversion and the various topologies it entails is considered to be within the scope of the notional addressee.

It should also be appreciated that while the exemplary embodiment described is directed to a bi-directional converter, the implementing principals remain the same for all converter topologies.

In use, and operating in rectifier mode, the control system 102 measures the input voltage 126 and the peak input current 128, and the output voltage 130.

Using the design equation for inductance, the measured input voltage and input current in combination with the switching device on-time (which is recorded by the microprocessor 106) can be used to calculate the total primary circuit inductance L_{P}. L_{P} includes the stray effects of circuit traces 114 and 118 and any variation in the transformer inductance 116.

The primary inductance value

$${L}_{P} = \frac{{V}_{IN} \times {T}_{ON}}{{I}_{IN}^{PEAK}}$$

Where:
L_{P} is the primary inductance
V_{IN} is the input voltage
T_{ON} is the time the switch is on, in seconds
I_{IN-PEAK} is the peak input current

The peak input current I_{PK} is related to the average input current I_{AV} by the relationship between the on period of the transistor switch to the off time of the switching device 104-1 to 104-4.

The Peak Input Current

$${I}_{IN}^{PEAK} = {I}_{IN}^{AVG} \times \frac{2 \times {T}_{SW}}{{T}_{ON}}$$

Where:
I_{IN-PEAK} is the peak input current
I_{IN-AVG} is the average input current
T_{ON} is the time the switch is on, in seconds
T_{SW} is the total switch cycle time in seconds

The output capacitance is determined by measuring the non-ideal switching characteristic of the switching device 104-1 to 104-4. The waveform shown in FIG. 2 is produced by a circuit using quasi resonant switching. The ringing 200 following the off period T_{OFF} of the switching device is caused by resonance between the primary inductance L_{P} and the total capacitance C_{TOT}. In quasi resonant circuits this trait is exploited by actively switching the switching device on in the valley, or low point of the ringing waveform. In FIG. 2 the switching device has been actively switched after time T_{SW}. The microprocessor measures the time T_{W} from when the switching device switches off to the first low point of the ringing waveform.

The frequency of the ringing is related to the magnitude of the primary inductance L and the total output capacitance C_{TOT} by the relationship:

T_{W}=\sqrt{π×L_{P}×C_{TOT}}

Where:
L_{P} is the primary inductance
C_{TOT} is the total output capacitance
T_{W} is the resonance timing

Based on the measured resonance timing and calculation of L_{P} from the measured input voltage V_{IN}, peak input current I_{PK} and transistor switch on time T_{ON} the total output capacitance can be calculated as:

$${C}_{TOT} = \frac{{T}_{W}^{2}}{{π}^{2} \times {L}_{P}}$$

From FIG. 2 it can be seen that the total switching time T_{SW} is the sum of the on time T_{ON}, the off time T_{OFF} and the resonance time T_{W} and the duration of the ringing. The resonance time is variable depending upon when the switch is actively turned back on. The total resonance time is determined by the number of valleys or low points in the ringing waveform, n_{Q}.

T_{SW}=T_{ON}+T_{OFF}+T_{W}×(1+2×n_{Q}) n_{Q}∈Z|n_{Q}≥0

The microprocessor calculates the required on time T_{ON} as a quadratic equation:

$${T}_{ON}^{2} \times \frac{{V}_{IN}}{2 \times {I}_{IN}^{PEAK} \times {L}_{P}} - {T}_{ON} \times ( 1 + \frac{{V}_{IN}}{{V}_{OUT} - {V}_{IN}} ) - {T}_{W} \times ( 1 + 2 \times {n}_{Q} )$$

Prior to being operated for the first time the microprocessor 106 relies on default values for primary inductance L and total capacitance C_{TOT} that have been pre-programmed into memory, such as ROM, EEPROM or the like.

In another exemplary embodiment, a minimum on time may be used as another design constraint. In such an embodiment, using the default values the control system 102 starts up to satisfy the condition for minimum on-time, although any arbitrary on time may be used provided it is greater than the minimum on-time. By starting at the minimum on time the output soft starts. The minimum on time will be known for a particular topology, the minimum on time being dictated by the limitations in the gate drive circuitry or limitations in the switching device 104-1 to 104-4. Other constraints on the minimum on-time may be present, such as recovery times for snubber circuitry. In such exemplary embodiments the minimum on time may be dictated by the longest of any such limitation.

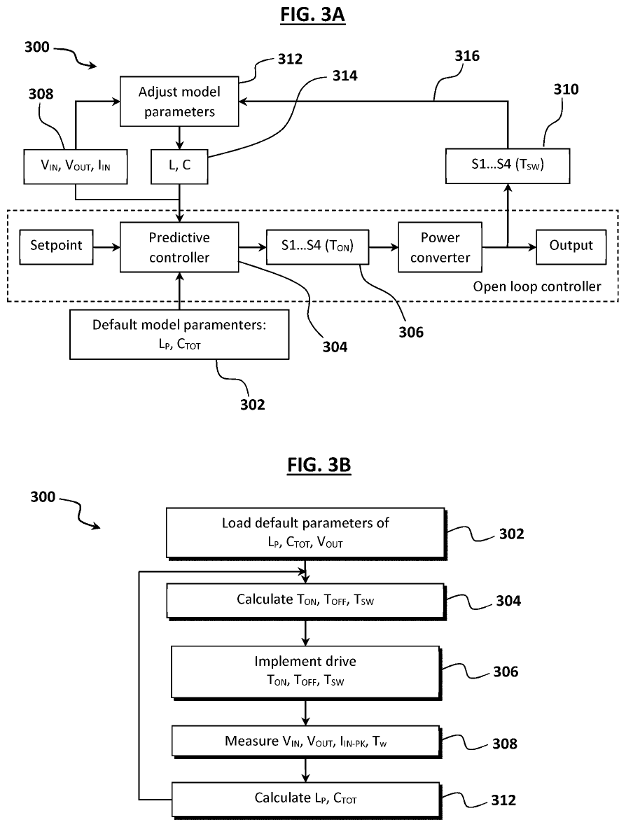

FIG. 3A shows a block diagram showing the stages and inputs for predictive control of the output of the bi-directional converter 100 of FIG. 1. This same process is shown as a flow diagram in FIG. 3B.

The default values for primary inductance L_{P} and total capacitance C_{TOT} and target output voltage V_{OUT} are retrieved from memory, shown by stage 302, and are used by the microprocessor 106 to calculate the off time T_{OFF} and resonance timing T_{W} as shown by stage 304.

The microprocessor 106 uses the calculated on-time T_{ON}, off-time T_{OFF}, and total switch time T_{SW} to drive the switching devices, shown in stage 306.

The input voltage V_{IN}, peak input current I_{IN-PK} and output voltage V_{OUT} are measured in substantially real-time, as indicated by stage 308.

The timing and non-ideal ringing characteristic of the switching device 104-1 to 104-4 is measured to determine the resonance timing T_{W}, shown in stage 310. Typically this involves timing the period from when the switching device 104-1 to 104-4 turns off until the first low of the ringing waveform. The subsequent lows are counted to determine the total duration of the ringing.

The measured input voltage V_{IN}, measured peak input current I_{PK} and the previously implemented switch on-time T_{ON} are used by the microprocessor 106 to calculate the value of primary inductance L_{P}. The calculated primary inductance L in combination with the measured resonance timing T_{W} is used by the microprocessor to calculate the total capacitance C_{TOT}, shown in stage 312. The calculated values of L_{P} and C_{TOT} are stored to memory and are used in future calculations of T_{ON}, T_{OFF} and T_{W} in place of the default values of L_{P} and C_{TOT}, shown in stage 314.

The microprocessor 106 re-calculates the on time T_{ON} using the calculated values for primary inductance L_{P} and total capacitance C_{TOT} and the process repeats, constantly adjusting for any variations in the primary inductance L_{P} and total capacitance C_{TOT}. This process is depicted by the feedback loop designated 316.

The primary inductance L_{P} is a function of the physical construction of the inductor, the material used and to a lesser extent the temperature of the transformer. The total capacitance C_{TOT} is a function of the switching device's capacitance, diode capacitance and capacitor type. All these capacitances are strongly affected by the input voltage and to a lesser extent the temperature of the PCB.

For accurate determination of primary inductance L_{P} the input voltage and current should be either sampled (including analogue and digital filters) faster than the rate of change of the pulse width modulated signal controlling the switching devices, or samples synchronously with the pulse width modulation signal, i.e. sampled at the peak current. Otherwise the variables in the equations will be out of sync and the instantaneous L_{P} result will be invalid.

For accurate determination of total capacitance C_{TOT} the switching waveform sampled by the microcontroller 106 must accurately represent the actual resonance waveform (in shape and delay) as closely as possible. Furthermore the latency of any software interrupts should be minimized and adjusted for.

An exemplary implementation of the exemplary bi-directional converter 100 of FIG. is described herein to assist with further understanding of the present disclosure. In this example the initial values of L_{P} and C_{TOT} programmed into the microprocessor 106 are 6.2 μH and 20 nF. The default minimum on time for the transistor switch is set within the microprocessor to be 2 μs. For the example the minimum on time of the transistor is dictated by the reset time for an active snubber across the transistor switch. Retrieval of the default values occurs in stage 302 of FIG. 3A. It should be appreciated that once the SMPS has been operated the values of L_{P} and C_{TOT} may be updated to match the most recently calculated values.

Based on the default values for T_{ON}, L and C_{TOT} the microprocessor 106 calculates the off time T_{OFF} and the resonance timing T_{W} and determines the timing of T_{ON}, T_{OFF} and T_{SW} as shown in stage 304 of FIG. 3B.

The microprocessor 106 activates the drive circuitry in drive block 108 to activate the transistors switches 104-1 to 104-4 using the calculated timing for T_{ON}, T_{OFF} and T_{SW}, as shown in stage 306 of FIG. 3B.

The microprocessor 106 measures the input voltage V_{IN}, output voltage V_{OUT}, and peak input current I_{IN-PK} by way of discrete electronic circuitry in DC sensing block 110 and AC sensing block 112. The switch resonance timing T_{W} is also measured by timing the period between when transistor switch 104-1 to 104-4 turns off at time T_{OFF} and the first low of the ringing effect shown in FIG. 2, as shown in stage 310 of FIG. 3B.

The microprocessor 106 calculates the primary inductance L_{P} and total capacitance C_{TOT} based on the measured values of input voltage V_{IN}, output voltage V_{OUT}, peak input current I_{IN-PK} and resonance timing T_{W}, as shown in stage 312 of FIG. 3B.

The process of predicting future transistor switch timing and re-calculating the primary inductance L_{P} and total capacitance C_{TOT} may be performed sequentially, or, in some embodiments the re-calculation of the primary inductance L and total capacitance C_{TOT} may be performed based on a timed interval.

FIG. 4 illustrates the real-time re-calculation of the primary inductance L and total capacitance C_{TOT}. In FIG. 4 the SMPS is powered on and after initialization of around 1 second the iterative process of driving the transistor switches 104-1 to 104-4 and recalculating L_{P} and C_{TOT} commences. The primary inductance L_{P} can be seen to resolve over a period of around 1 second from its default value of 6.2 μH to its operating value of 5 μH. The total capacitance C_{TOT} resolves from its default value of 15 nF to 20 nF over a period of around 3 seconds. It will be appreciated that the timing shown in FIG. 4 may vary and is provided as an example only.

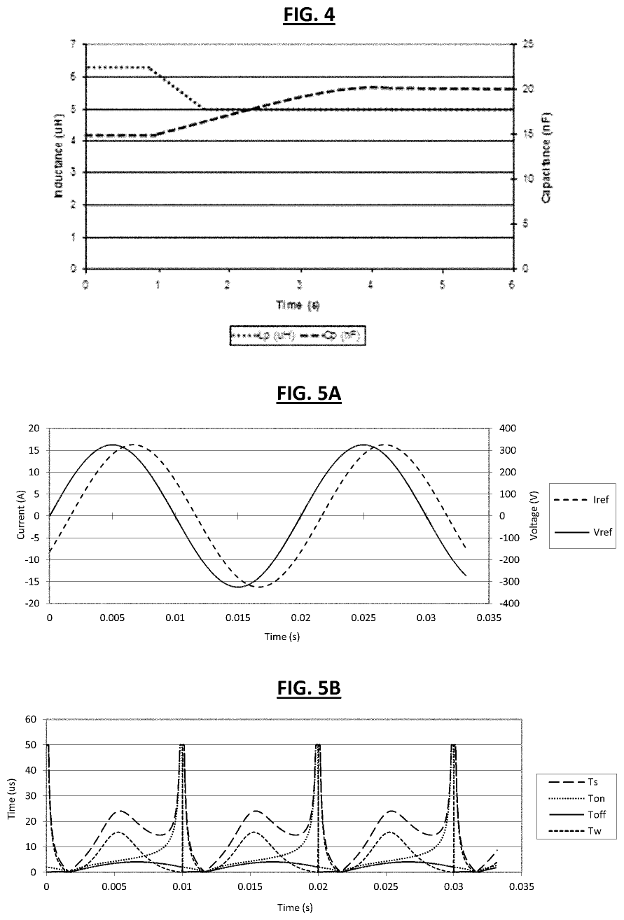

FIG. 5a shows the substantially real time measurements of the input voltage V_{IN} and input current I_{N}, while FIG. 5b shows the calculated switch on timing T_{ON}, off timing T_{OFF} and resonance timing T_{W}.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof as defined in the appended claims.

1. A method for predictive control of the output of a switched mode power supply, the method including the steps of:
a) measuring at least one dependent variable related to an output of the switch mode power supply to be controlled;
b) measuring, substantially in real-time, at least one non-ideal switching characteristic of the power supply;
c) calculating at least one substantially real-time physical property of the switch mode power supply based on the non-ideal switching characteristic;
d) calculating, based on the measured dependent variable and calculated real-time physical property, an adjustment to at least one independent variable of the switch mode power supply required to adjust the output of the switch mode power supply to be controlled;
e) adjusting the independent variable of the switch mode power supply;
f) repeating steps (a) to (e).

2. The method of claim 1, wherein the at least one dependent variable is at least one of: output current, output voltage, input current, input voltage, input power factor, supply frequency, and harmonic distortion.

3. The method of claim 1, wherein the at least one non-ideal switching characteristic is at least one of: switch ringing, signal to noise ratio, switch conductance, switch transconductance, and switch latency.

4. The method of claim 1, wherein the at least one physical property of the switch mode power supply that is calculated in substantially real time includes at least one of: the parasitic or stray inductance of at least a portion of the switch mode power supply circuit, the trace inductance, and the component lead inductance.

5. (canceled)

6. The method of claim 1, wherein the physical property of the switch mode power supply that is calculated in substantially real time includes one or more of: the parasitic or stray capacitance of at least a portion of the switch mode power supply circuit, the switching device parasitic capacitance, the switch mode power supply output trace stray capacitance, and the switch mode power supply inter component stray capacitance.

7. (canceled)

8. The method of claim 1, wherein the at least one physical property of the switch mode power supply that is calculated in substantially real time includes at least one of: the input inductance, and the total capacitance.

9. (canceled)

10. The method of claim 1, wherein the at least one independent variable of the switch mode power supply that is adjusted to vary the output of the switch mode power supply includes at least one of: switching frequency, switching dead time, and switching duty cycle.

11. The method of claim 1, wherein calculation of the adjustment to the independent variable of the switch mode power supply is determined from a set of design equations based on the specific design of switch mode power supply.

12. The method of claim 11, wherein at least one of the design equations includes as a variable the calculated physical property of the switch mode power supply.

13. A predictive controller for a switched mode power supply, the predictive controller including:
a sensing circuit configured to measure, in substantially real time:
at least one dependent variable related to an output of the switch mode power supply, and
at least one non-ideal switching characteristic of the power supply;
a controller in communication with the sensing circuit, configured to:
calculate at least one substantially real-time physical property of the switch mode power supply based on the measured non-ideal switching characteristic;
calculate a future adjustment to at least one independent variable of the switch mode power supply based on the measured dependent variable and the calculated real-time physical property; and
adjust the independent variable based on the calculated future adjustment.

14. The predictive controller of claim 13, wherein the at least one dependent variable which the sensing circuit is configured to measure is at least one of: output current, output voltage, input current, input voltage, input power factor, supply frequency, and harmonic distortion.

15. The predictive controller of claim 13, wherein the at least one non-ideal switching characteristic which the sensing circuit is configured to measure is at least one of: switch ringing, signal to noise ratio, switch conductance, switch transconductance, and switch latency.

16. The predictive controller of claim 13, wherein the at least one physical property of the switch mode power supply that is calculated in substantially real time by the controller includes one or more of: the parasitic or stray inductance of at least a portion of the switch mode power supply circuit, the trace inductance, and the component lead inductance.

17. (canceled)

18. The predictive controller of claim 13, wherein the physical property of the switch mode power supply that is calculated in substantially real time by the controller includes at least one of: the parasitic or stray capacitance of at least a portion of the switch mode power supply circuit, the switching device parasitic capacitance; the switch mode power supply output trace stray capacitance, and the switch mode power supply inter component stray capacitance.

19. (canceled)

20. The predictive controller of claim 13, wherein the at least one physical property of the switch mode power supply that is calculated in substantially real time by the controller includes at least one of: the input inductance, and the total capacitance.

21. (canceled)

22. The predictive controller of claim 13, wherein the at least one independent variable of the switch mode power supply that is adjusted by the controller to vary the output of the switch mode power supply includes at least one of: switching frequency, switching dead time, and switching duty cycle.

23. The predictive controller of claim 13, wherein calculation of the adjustment to the independent variable of the switch mode power supply by the controller is determined from a set of design equations based on the specific design of switch mode power supply.

24. The predictive controller of claim 23, wherein at least one of the design equations includes as a variable the calculated physical property of the switch mode power supply.

25. A switch mode power supply, including a predictive controller including:
a sensing circuit configured to measure, in substantially real time:
a dependent variable related to an output of the switch mode power supply, and
a non-ideal switching characteristic of the power supply;
a controller in communication with the sensing circuit configured to:
calculate a substantially real-time physical property of the switch mode power supply based on the measured non-ideal switching characteristic;
calculate a future adjustment to an independent variable of the switch mode power supply based on the measured dependent variable and the calculated real-time physical property; and
adjust the independent variable based on the calculated future adjustment.

26. (canceled)
